(19) United States
(12) Patent Application Publication
(10) Pub. No.: US 2011/0119044 A1
(43) Pub. Date: May 19, 2011

(54) PROCESSOR SIMULATION USING INSTRUCTION TRACES OR MARKUPS

(76) Inventor: Anthony Dean Walker, Rougemont, NC (US)

(21) Appl. No.: 12/198,595

(22) Filed: Aug. 26, 2008

(51) Int. Cl. G06F 9/455

(52) U.S. Cl. 703/20

(57) ABSTRACT

An efficient, cycle-accurate processor execution simulator models a target processor by executing a program execution image comprising instructions having run-time dependencies resolved by execution on an existing processor compatible with the target processor. The instructions may have been executed upon a processor in an I/O environment too complex to model. In one embodiment, the simulator executes instructions that were directly executed on a processor. In another embodiment, a markup engine alters a compiled program image, with reference to instructions executed on a processor, to remove run-time dependencies. The marked up program image is then executed by the simulator. The processor execution simulator includes an update engine operative to cycle-accurately simulate instruction execution, and a communication engine operative to model each communication bus of the target processor.

### FIELD OF THE INVENTION

The present invention relates generally to microprocessor system simulation, and in particular to a simulation methodology utilizing cycle-accurate, or cycle approximate, models and instructions having run-time dependencies resolved by execution on a processor.

### BACKGROUND

Simulation of processor designs, and processor-based systems, is well known in the art. Indeed, extensive simulation is essential to the process of new processor design. Simulation involves modeling a target system by quantifying the characteristics of system components and relating those characteristics to one another such that the emergent model (that is, the sum of the related characteristics) provides a close representation of the actual system.

One known method of simulation provides hardware-accurate models of system components, such as Hardware Description Language (HDL) constructs, or their gate-level realizations following synthesis, and simulates actual device states and signals passing between the components. These simulations, while highly accurate, are relatively slow, computationally demanding, and can only occur well into the design process when hardware-accurate models have been developed. Accordingly, they are ill-suited for early simulations useful in illuminating architectural tradeoffs, benchmarking basic performance, and the like.

A more efficient method of simulation provides higher-level, cycle-accurate models of hardware components, and models their interaction via a transaction-oriented messaging system. The messaging system simulates real-time execution by dividing each clock cycle into an “update” phase and a “communicate” phase. Cycle-accurate component functionality is simulated in the appropriate update phases in order to simulate actual component behavior. Inter-component signaling is allocated to communicate phases in order to achieve cycle-accurate system execution. The accuracy of the simulation depends on the degree to which the component models accurately reflect the actual component functionality and accurately stage inter-component signaling. Highly accurate component models—even of complex components such as processors—are known in the art, and yield simulations that match real-world hardware results with high accuracy in many applications.

Component accuracy, however, is only part of the challenge of obtaining high fidelity simulations of complex components such as processors. Meaningful simulations additionally require accurately modeling activity on the processor, such as instruction execution order and the range of data address references. In many applications, processor activity may be accurately modeled by simply executing relevant programs on the processor model. However, this is not always possible, particularly when modeling real-time processor systems. For example, the input/output behavior (I/O) may be a critical area to explore, but the actual I/O environment is sufficiently complex to render the development of an accurate I/O model impossible or impractical. This is the situation with respect to many communication-oriented systems, such as mobile communication devices. One solution to this problem is to simply excise (or disable) I/O functionality in the simulation model. However, this is of no help when the I/O interactions are precisely the aspects of processor execution for which the simulation is being run.

### SUMMARY

According to one or more embodiments of the present invention, an efficient, cycle-accurate processor execution simulator models a target processor by executing a program execution image comprising instructions having run-time dependencies resolved by execution on an existing processor compatible with the target processor. The instructions may have been executed upon a processor in an I/O environment too complex to model. In one embodiment, the simulator executes instructions that were directly executed on a processor. In another embodiment, a markup engine alters a compiled program image, with reference to instructions executed on a processor, to remove run-time dependencies. The marked up program image is then executed by the simulator.

The processor execution simulator includes an update engine operative to cycle-accurately, or cycle approximately, simulate instruction execution, and one or more communication engines, each operative to model a communication bus of the target processor. The simulator employs a transaction-oriented messaging system wherein each system clock cycle is divided into an “update” phase and a “communicate” phase. The update and communication engines simulate processor components or functions in each update phase, and transfer messages and data in each communicate phase.

### BRIEF DESCRIPTION OF THE DRAWINGS

FIG. 1 is a functional block diagram of a program execution simulator.

FIG. 2 is a functional block diagram of a program execution simulator and a program markup engine.

FIG. 3 is a flow diagram of a method of simulation in an update engine.

FIG. 4 is a flow diagram of a method of simulation in a communication engine.

### DETAILED DESCRIPTION

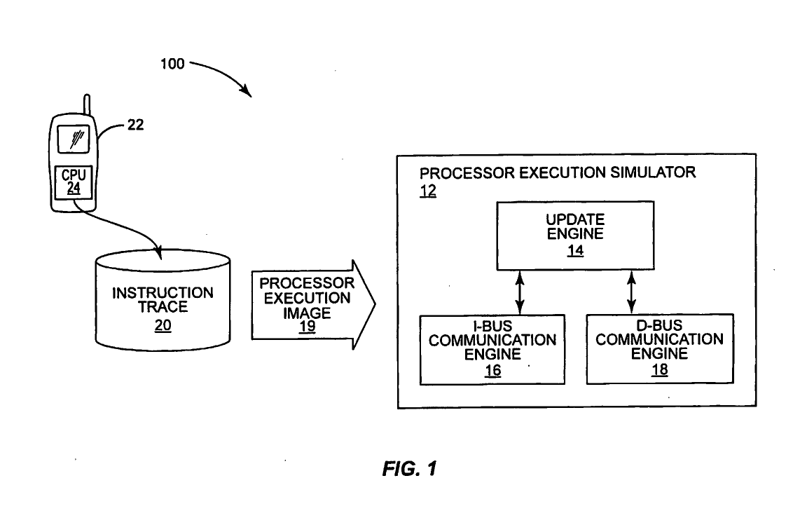

FIG. 1 depicts a processor simulation environment 100 including a processor execution simulator 12. The processor execution simulator 12 includes an update engine 14, which models a particular, target processor (which may be an existing processor or, more likely, a processor under development). In the embodiment depicted, the target processor includes separate instruction and data buses. Accordingly, the processor execution simulator 12 includes two communication engines—I-bus communication engine 16 and D-bus communication engine 18—each of which models a bus on the target processor.

The processor execution simulator 12 executes a processor execution image 19 comprising a series of instructions from, or marked up with reference to, an instruction trace 20, as explained further herein. The instruction trace 20 comprises instructions that were actually executed on an existing processor 24 compatible with the target processor. A processor is compatible with the target processor if it implements the same instruction set architecture. In one embodiment, to ensure maximum compatibility, an existing processor 24 is an immediately prior version of the target processor. The processor execution image 19 thus comprises a series of instructions in which the program path, or order of instruction execution; data and I/O addresses; and other run-time dependencies have been resolved by execution on a real processor 24.

In the embodiment depicted in FIG. 1, the program execution image 19 comprises an instruction trace 20 of instructions actually executed on a processor 24. For example, the processor 24 may be deployed in a mobile communication device 22, and the instruction trace 20 may have been obtained when the communication device 22 was engaged in actual wireless communications—an I/O environment of such complexity that it is impossible or impractical to simulate it. By capturing the instructions executed on the processor 24, the actual, real-world, run-time behavior of the processor 24 for a given software program, in an actual, rich I/O environment, is captured. This behavior is then simulated on the processor execution simulator 12, allowing for analysis of the architecture and features of the target processor in the un-simulatable I/O environment.

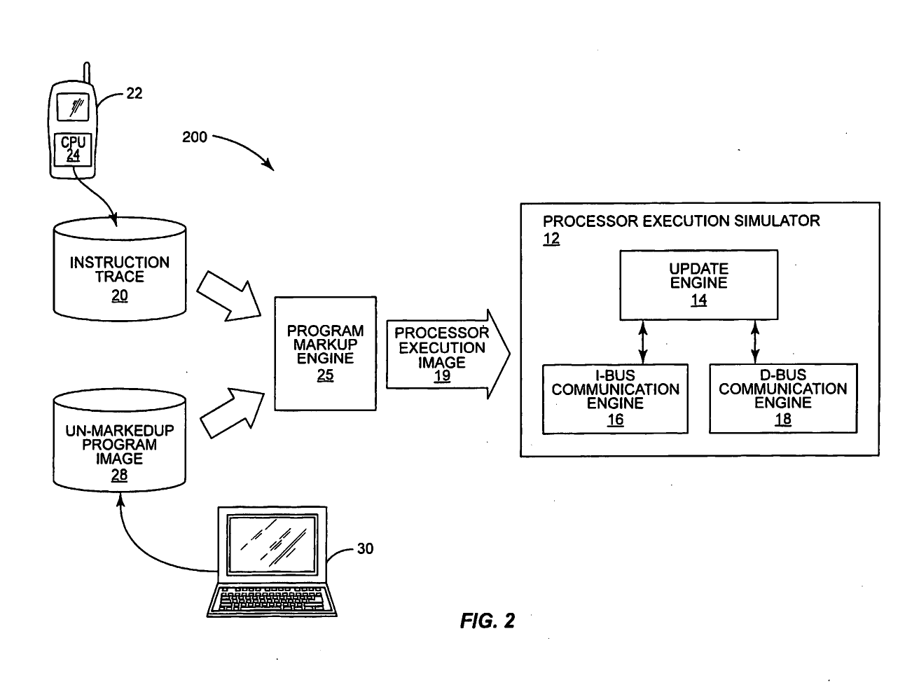

Another embodiment of a processor simulation environment 200 is depicted in FIG. 2. A program execution simulator 12 comprising an update engine 14 and I-bus and D-bus communication engines 16, 18 simulates a target processor by executing instructions from a program execution image 19. In this embodiment, however, the program execution image 19 is not obtained directly from the instruction trace 20. Rather, one or more software modules are compiled and linked in a software development environment 30, yielding an un-marked-up program image 28. The un-marked-up program image 28 is an object file that can be loaded into memory for execution.

As known in the art, every real-world un-marked-up program image 28 includes conditional instructions, such as for example conditional branch instructions, whose actual behavior is not known until run-time—indeed, often not until the instruction reaches an execution stage deep in the pipeline. As one example of how such conditional instructions arise, consider a software loop construct. Prior to (or following) each iteration of the loop, some condition is tested to determine if the loop should terminate or execute another iteration. In response to the condition evaluation, program instruction execution will then proceed sequentially, or will jump (forward or backward) and begin execution at a different point in the instruction stream. While the behavior of the conditional branch instruction may be predicted (sometimes with high accuracy), its actual behavior is not known until the condition is evaluated at run-time. Furthermore, the condition evaluation may depend on a complex, un-simulatable I/O environment, such as real-time wireless communications.

All such conditional instructions—as well as other run-time behaviors such as I/O and memory address calculations, register utilization, subroutine calls, and the like—may be resolved by executing the un-marked-up program image 28 on a real processor 24, e.g., in a mobile communication device 22 engaged in actual wireless communications. The instruction trace 20 of instructions executed on the processor 24 is captured and stored.

A program markup engine 25 receives the un-marked-up program image 28 and the instruction trace 20. The program markup engine 25 analyzes the instruction trace 20 and marks up, or alters, the un-marked-up program image 28 to remove I/O dependencies, resolve conditional branches, and the like. Other real-time behavior, such as a change in program control due to a hardware interrupt, may be emulated by inserting a software interrupt instruction directed to the interrupt vector. The program markup engine 25 then outputs a marked-up version of the program image as the program execution image 19, which is executed by the processor execution simulator 12.

In either embodiment—that is, whether the program execution image 19 is derived directly from the instruction trace 20 (FIG. 1), or the program markup engine 25 (FIG. 2), the instructions are executed using a transaction-oriented messaging system. The messaging system provides for cycle-accurate simulations of real-time execution by dividing each clock cycle into an “update” stage and a “communicate” stage.

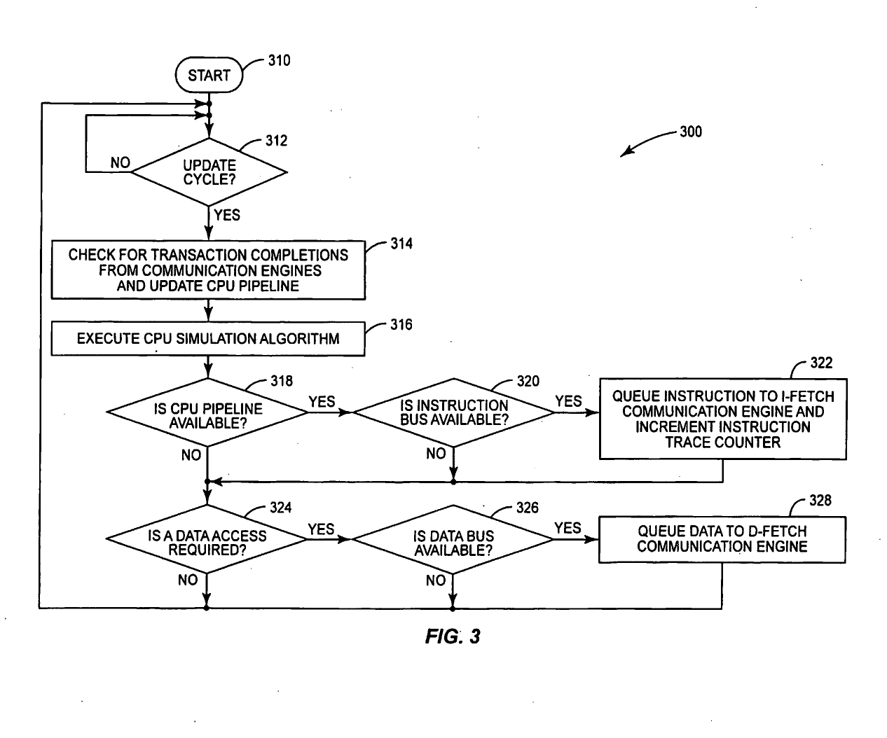

FIG. 3 depicts a method 300 of simulating instructions in the update engine 14. Starting at block 310, the method waits for the “update” phase of the system clock (block 312). When the update phase begins, the update engine 14 checks for any transaction completion messages from the communication engines 16, 18, and updates the processor pipeline accordingly (block 314). The update engine 14 then executes a processor simulation algorithm on one or more instructions in one or more simulated pipelines (block 316). If a processor pipeline is available (block 318)—that is, a pipeline can accept a new instruction—and the instruction bus is available (block 320), then the update engine 14 queues one or more instruction fetch requests to the I-bus communication engine 16 and increments an instruction trace counter (block 322). If a data access is required (block 324), and the data bus is available (block 326), the update engine 14 queues one or more data access requests to the D-bus communication engine 18. The update engine 14 then waits for the next update cycle (block 312). Any instruction or data access requests to the communication engines 16, 18 will be sent, and any transaction completion messages from the communication engines 16, 18 will be received, during the “communicate” phase of the system clock prior to the next update phase.

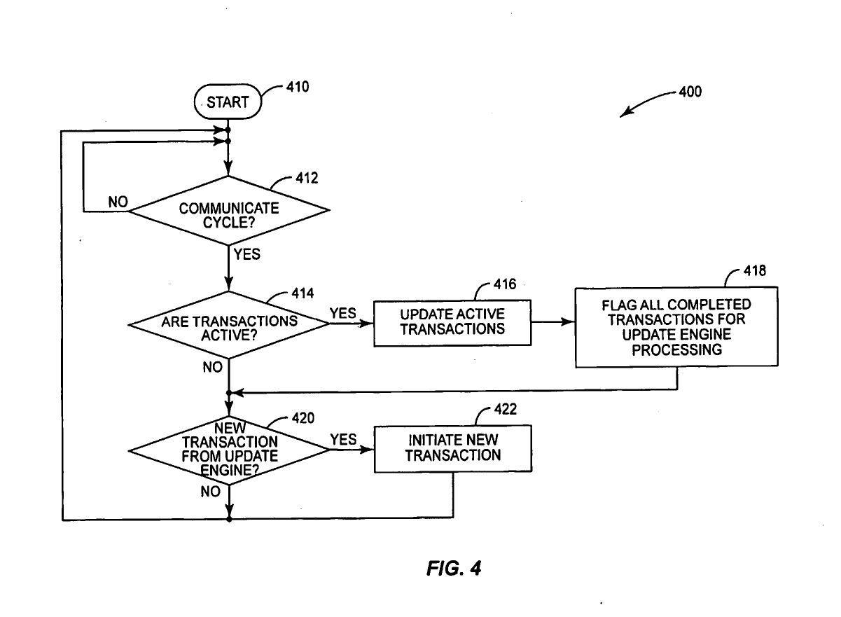

FIG. 4 depicts a method 400 of simulating a data bus in a communication engine 16, 18. Starting at block 410, the method waits for the “communicate” phase of the system clock (block 412). When the communicate phase begins, the communication engine 16, 18 checks whether any bus transactions are active (block 414). If so, the communication engine 16, 18 updates all active transactions (block 416) and flags all completed transactions for processing by the update engine 14 (block 418). The communication engine 16, 18 then checks for any new transaction requests from the update engine 14 (block 420). If a new transaction request is found, the communicate engine 16, 18 initiates a new bus transaction (block 422). The communication engine 16, 18 then waits for the next communicate cycle (block 412). Instructions or (read) data are provided to the update engine 14 for any completed bus transactions, and any new transaction requests are received from the update engine 14, during the “update” phase of the system clock prior to the next communicate phase.

In this manner, and by executing a program execution image 19 comprising instructions having run-time dependencies resolved by execution on an existing processor 24, accurate simulation of a target processor in a complex I/O environment may be achieved. Such simulation is useful for validation of expected use cases, tuning of processor capability, tuning of memory sizes and configurations (including cache size, organization, and replacement algorithm; virtual-to-physical memory translation page sizes; overall memory requirements; and the like), comparison of alternative architectures, performance impact of power-saving features, and the like. The update engine 14 may be written to simulate any processor, including superscalar designs, Digital Signal Processors (DSP), real-time processors, RISC or CISC architectures, or the like.

The simulation allows modeling of a target processor prior to its actual realization. It enables modeling when the I/O environment of greatest interest is so complex as to be impossible or impractical to model. The simulation methodology is scalable, and may range from a simple pacing algorithm based on benchmark performance to a detailed processor hardware reproduction. It provides greater accuracy than a statistical generation approach, yet provides increased simulation speed and requires fewer computational resources compared to a simulation of hardware-accurate component models.

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

What is claimed is:

1. A method of simulating operation of a target processor, comprising:
providing a processor execution image comprising a sequence of processor instructions having run-time dependencies resolved by execution on an existing processor compatible with the target processor; and
feeding the processor execution image to a target processor execution simulator comprising
an update engine operative to simulate the execution of each instruction according to characteristics of the target processor, and
one or more communication engines, each operative to simulate a data communication bus in the target processor; and
monitoring the simulated performance of the target processor.

2. The method of claim 1 further comprising providing a transaction-oriented messaging system wherein each system clock cycle comprises an update phase and a communicate phase.

3. The method of claim 2 wherein the update engine is operative to cyclically perform the following steps, in order:
(a) wait for a new update phase;
(b) check for transaction completions from one or more communication engines and update one or more simulated target processor pipelines in response to any completed communication engine transactions;
(c) simulate the execution of one or more instructions from the processor execution image; and
(d) check if an instruction or data access is required, and if so
(i) check the availability of a relevant communication bus; and
(ii) if the relevant communication bus is available, initiate a communication bus transaction.

4. The method of claim 3 further comprising receiving any transaction completions from a communication engine, transferring a communication bus transaction request to one or more communication engine, or both, during a communication phase prior to the next update phase.

5. The method of claim 3 wherein the target processor includes an instruction bus, the target processor execution simulator includes an instruction bus communication engine, and an instruction access is required whenever a target processor pipeline is available, and further comprising incrementing an instruction trace counter upon initiating an instruction communication bus transaction.

6. The method of claim 3 wherein the target processor includes a data bus and the target processor execution simulator includes a data bus communication engine.

7. The method of claim 2 wherein each communication engine is operative to cyclically perform the following steps, in order:
(a) wait for a new communicate phase;
(b) check if any communication bus transactions are active and if so
(i) update active communication bus transactions and
(ii) flag completed communication bus transactions for update engine processing; and
(c) check for any new transaction request from the update engine and if found,
(i) initiate a new communication bus transaction.

8. The method of claim 7 further comprising receiving any new transaction request from the update engine during an update phase prior to the next communicate phase.

9. The method of claim 1 wherein providing a processor execution image comprising a sequence of processor instructions having run-time dependencies resolved by execution on an existing processor compatible with the target processor comprises providing a processor execution image comprising instructions executed on an existing processor compatible with the target processor.

10. The method of claim 1 wherein providing a processor execution image comprising a sequence of processor instructions having run-time dependencies resolved by execution on an existing processor compatible with the target processor comprises:
providing an unmarked program image comprising a series of instruction obtained by compiling and linking a program;
providing a program execution trace comprising a series of instructions obtained by executing the unmarked program image on an existing processor compatible with the target processor; and
marking up the unmarked program image based on the program execution trace to generate the processor execution image having run-time dependencies resolved.

11. The method of claim 10 wherein marking up the unmarked program image based on the program execution trace comprises removing input/output dependencies in the unmarked program image based on the resolution of the input/output dependencies reflected in the program execution trace.

12. The method of claim 10 wherein marking up the unmarked program image based on the program execution trace comprises resolving conditional branch instructions in the unmarked program image based on the resolution of execution path reflected in the program execution trace.

13. A target processor execution simulator, comprising:
an update engine operative to receive and simulate a processor execution image comprising a sequence of processor instructions having run-time dependencies resolved by execution on an existing processor compatible with the target processor; and
one or more communication engines, each operative to simulate a data communication bus in the target processor.

14. The simulator of claim 13 wherein the simulator receives a system clock signal wherein each cycle comprises an update phase and a communicate phase.

15. The simulator of claim 14 wherein the update engine is operative to cyclically perform the following steps, in order:
(a) wait for a new update phase;
(b) check for transaction completions from one or more communication engines and update a simulated target processor pipeline in response to any completed communication engine transactions;
(c) simulate the execution of one or more instructions from the processor execution image; and
(d) check if an instruction or data access is required, and if so
(i) check the availability of a relevant communication bus; and
(ii) if the relevant communication bus is available, initiate a communication bus transaction.

16. The simulator of claim 15 wherein the simulator is operative to any transaction completions from a communication engine to the update engine, transfer a communication bus transaction request from the update engine to one or more communication engines, or both, during a communication phase prior to the next update phase.

17. The simulator of claim 14 further comprising, if the target processor includes an instruction bus, an instruction bus communication engine; and wherein
an instruction access is required whenever a target processor pipeline is available; and
an instruction trace counter is incremented when the update engine initiates an instruction communication bus transaction.

18. The simulator of claim 14 further comprising, if the target processor includes a data bus, a data bus communication engine.

19. The simulator of claim 14 wherein each communication engine is operative to cyclically perform the following steps, in order:
(a) wait for a new communicate phase;
(b) check if any communication bus transactions are active and if so
(i) update active communication bus transactions and
(ii) flag completed communication bus transactions for update engine processing; and
(c) check for any new transaction request from the update engine and if found,
(i) initiate a new communication bus transaction.

20. The simulator of claim 13 further comprising a program markup engine operative to:
receive an unmarked program image comprising a series of instruction obtained by compiling and linking a program;
receive a program execution trace comprising a series of instructions obtained by executing the unmarked program image on an existing processor compatible with the target processor; and
mark up the unmarked program image based on the program execution trace to generate the processor execution image having run-time dependencies resolved.

21. The simulator of claim 20 wherein the program markup engine is operative to mark up the unmarked program image based on the program execution trace by removing input/output dependencies in the unmarked program image based on the resolution of the input/output dependencies reflected in the program execution trace.

22. The simulator of claim 20 wherein the program markup engine is operative to mark up the unmarked program image based on the program execution trace by resolving conditional branch instructions in the unmarked program image based on the resolution of execution path reflected in the program execution trace.
